(19) United States
(12) Patent Application Publication
(10) Pub. No.: US 2007/0011819 A1
(43) Pub. Date: Jan. 18, 2007

(54) Method and composition for pretreating fabric for direct printing

(75) Inventors: Roy F. DeVries, Oakland, NJ (US); Robert F. DeVries, New City, NY (US); Henry Louis, Wycoff, NJ (US); Mark Louis, Wycoff, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Screen-Trans Development Corp., Moonachie, NJ (US)

(21) Appl. No.: 11/477,183

(22) Filed: Jun. 28, 2006

Related U.S. Application Data
(60) Provisional application No. 60/697,231, filed on Jul. 7, 2005.

(51) Int. Cl. C11D 3/00

(52) U.S. Cl. 8/115.51

(57) ABSTRACT

The present invention provides a composition and method for pretreating a natural, synthetic or blended fabric so that a colored image can be printed directly thereon by a printer. The composition of the present invention comprises an ink receptor, a surfactant, a flame retardant, a fluorescent whitening agent, and water. The method of the present invention comprises pretreating a fabric using a composition comprising an ink receptor, a surfactant, a flame retardant, a fluorescent whitening agent, and water, and drying the fabric thereafter.

### CROSS-REFERENCE TO RELATED APPLICATIONS

This application claims the benefit of the filing date of U.S. Provisional Patent Application No. 60/697,231 filed Jul. 7, 2005, the disclosure of which is hereby incorporated herein by reference.

### BACKGROUND OF THE INVENTION

Transfer printing is a process whereby an image is printed first onto a paper and then transferred to a textile fabric. First, a paper is specially treated for: transfer printing. This treated paper is frequently referred to as a heat transfer paper. Next, a colored image is printed onto the paper using any number of commercial printing processes such as gravure, lithographic, flexographic, screen, flat, rotary and digital. The inks used for the heat transfer printing process are specifically of the type that volatilize or sublime at specific temperatures depending on the fabric used. The printed paper is placed image face down on the fabric and then subjected to the desired appropriate temperature. The ink on the paper volatilizes or sublimes and migrates to the fabric. This entire process is generally referred to as “heat transfer printing.” Fabrics generally used in the heat transfer printing are polyester, and temperatures involved are usually about 400° F. to ensure the most complete transfer of the ink from the paper to the fabric. At these temperatures, the ink on the paper volatilizes or sublimates and the resulting gases are captured by the individual fibers of the fabric. The method yields a permanent image on the fabric in virtually any range of colors.

A disadvantage of this method, however, is that it involves multiple steps in printing a colored image to a fabric (i.e., initial preparation of the specially coated paper, then printing on the paper, and then transferring the image to the fabric using heat), and therefore this method is time-consuming and laborious. Therefore, there is a need for a new and improved method and composition for pretreating a fabric so that an image can be printed directly thereon by a printer, saving time and cost involved in a printing process.

There are a number of patents which describe types of pretreatment compositions available for a heat transfer printing or a direct printing process. Some of those are briefly discussed below.

U.S. Pat. No. 4,119,398 (Purser) also describes a composition for pretreating fabric, however, for use in heat transfer printing wherein the image is transferred from a specially coated paper to a fabric using heat. Heat transfer printing is a very cumbersome method of printing as explained above.

U.S. Pat. No. 6,040,014 (Izmirlian et al.) (“the '014 Patent”) discloses a method and composition for pretreating fabrics to facilitate direct printing on the fabric. This patent teaches a pretreatment paste comprising fatty acid ester, a silicone elastomer and a thickening agent with a viscosity of between 2,000-4,000 cps to apply the pretreatment paste onto the fabric through screens using a screen-printing method. However, the pretreatment method and composition described in the '014 Patent does not provide a fabric which is smooth, soft and drapy. Therefore, the fabrics treated with the pretreatment composition of the '014 Patent are not suitable to be used as flags, banners, displays, window decorations, partitions, clothes, etc. Moreover, the fabrics treated with the pretreatment composition of the '014 Patent still do not provide the color yield, sharpness and brilliancy as the images that are heat transfer printed onto a fabric from a paper.

Therefore, there is still a great need to develop a simple, economical, more efficient and high performing pretreatment process and composition for preparing a pretreated fabric for use in a direct printing process.

### SUMMARY OF THE INVENTION

The present invention relates in general to a method and composition for pretreating a fabric so that an image can be printed directly thereon by a printer.

More specifically, in one embodiment, the present invention relates to a pretreatment composition for pretreating a fabric for use in direct printing comprising: about 5 weight % to about 40 weight % of an ink receptor, about 0.5 weight % to about 4 weight % of a surfactant, about 0.1 weight % to about 5 weight % of a fluorescent whitening agent, about 0.5 weight % to about 10 weight % of a flame retardant, and about 10 weight % to about 90 weight % of water.

In accordance with one aspect of the invention, a pretreatment composition for pretreating a fabric for use in direct printing comprises about 5 weight % to about 40 weight % of an ink receptor, about 0.5 weight % to about 4 weight % of a surfactant, about 0.1 weight % to about 5 weight % of a fluorescent whitening agent, about 0.5 weight % to about 10 weight % of a flame retardant, 0.1 weight % to about 2 weight % of a thickening agent, and about 10 weight % to about 90 weight % of water.

In accordance with another aspect of the invention, there is provided a method of applying a pretreatment composition to a fabric for use in direct printing comprising: applying a pretreatment composition comprising about 5 weight % to about 40 weight % of an ink receptor, about 0.5 weight % to about 4 weight % of a surfactant, about 0.1 weight % to about 5 weight % of a fluorescent whitening agent, about 0.5 weight % to about 10 weight % of a flame retardant, and about 10 weight % to about 90 weight % of water to a fabric, and drying said fabric thereafter.

In yet another aspect of the invention, there is provided a method of applying a pretreatment composition to a fabric for use in direct printing comprising: applying a pretreatment composition comprising about 5 weight %l to about 40 weight % of an ink receptor, about 0.5 weight % to about 4 weight % of a surfactant, about 0.1 weight % to about 5 weight % of a fluorescent whitening agent, about 0.5 weight % to about 10 weight % of a flame retardant, about 0.1 weight % to about 2 weight % of a thickening agent, and about 10 weight % to about 90 weight % of water to a fabric, and drying said fabric thereafter.

The present invention is a significant advance. The methods and compositions of the present invention provide improvements whereby printing a colored image can be carried out directly onto a fabric without the intermediate steps of printing on a paper first and then transferring the image to a fabric using heat. Moreover, a directly printed colored image on a pretreated fabric using the methods and/or compositions of the present invention provides better than or at least the same degree of color yield, sharpness and brilliancy as the images that are heat transfer printed onto a fabric from a paper. Furthermore, the fabrics pretreated using the methods and compositions of the present invention allow a colored image to be printed directly onto a fabric while imparting lubricity, softness and draping characteristics to the fabrics.

The present invention provides simple, economical, efficient and high performance pretreatment compositions and methods.

### BRIEF DESCRIPTION OF THE DRAWINGS

It should be understood that the drawing is provided for the purpose of illustration only and is not intended to define the limits of the invention. The foregoing and other objects and advantages of the embodiments described herein will become apparent with reference to the following detailed description when taken in conjunction with the accompanying drawing in which:

FIG. 1 illustrates a step of applying a pretreatment composition of the present invention to a fabric by dipping the fabric into the pretreatment solution, and a step of drying the pretreated fabric thereafter.

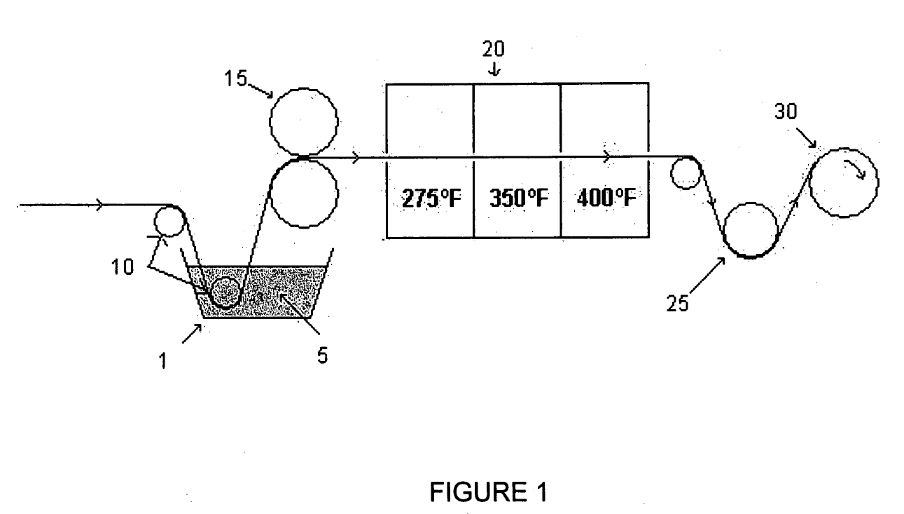

### DETAILED DESCRIPTION

Throughout the entire specification, including the claims, the word “comprise” and variations of the word, such as “comprising” and “comprises, ” as well as “have,” “having,” “includes,” “include” and “including,” and variations thereof, means that not only the named steps, elements or materials to which it refers form a construct within the scope of the claim or disclosure, but also other steps, elements or materials that may be added form a construct within the scope of the claim or disclosure. When recited in describing the invention and in a claim, it means that the invention and what is claimed is considered to be what follows and potentially more. These terms, particularly when applied to claims, are inclusive or open-ended and do not exclude additional, unrecited elements or methods steps. The term “between” as used in connection with a range includes the endpoints unless the context suggests otherwise. All references to testing are at room temperature unless otherwise specified and all references to temperature are in degrees Fahrenheit unless otherwise specified.

In describing the preferred embodiments of the present invention, a specific terminology will be resorted to for the sake of clarity. However, the invention is not intended to be limited to the specific terms so selected, and is to be understood that each specific term includes all technical equivalence which operates in a similar manner to accomplish a similar purpose.

The present invention provides a composition and method for pretreating natural, synthetic and/or blended fabrics so that a colored image using sublimation dye, acid dye, direct dye or pigment can be printed directly thereon by a printer, preferably a digital printer.

In the present invention, it has been surprisingly discovered that an image can be directly printed onto a fabric without the intermediate steps (i.e., initial preparation of the specially coated paper, then printing on the paper, and then transferring the image to the fabric using heat), and still produce a colored image which is better than or at least the same degree of color yield, sharpness and brilliancy as the images that are heat transfer printed onto a fabric from a paper.

Moreover, it has also been surprisingly discovered that the pretreated fabrics in accordance with the present invention are smooth, soft and drapy which make them suitable for flags, banners, displays, window decorations, partitions, clothes, etc.

Furthermore, the present invention provides a simple, efficient and high performance pretreatment composition so a pretreated fabric can be used for direct printing, reducing the amount of time and energy required for printing a high quality colored image onto a fabric.

In one preferred embodiment, the pretreatment composition of the present invention comprises an ink receptor, a surfactant, a flame retardant, a fluorescent whitening agent, and water. In another preferred embodiment, the composition further comprises a thickening agent.

An ink receptor is used in the present invention to stabilize the fabric and serve as an antimigrant agent. More specifically, the ink receptor of the present invention is used to control the mobility of dye particles in an aqueous system and to control migration of the dye during the drying or thermofixation process.

Non-limiting examples of ink receptors which can be used in accordance with the present invention include, but are not limited to, a polyacrylic resin, styrene-acrylic copolymer, a mixture of polyacrylic resins, cross-linked polyvinylpyrrolidone, cross-linked polyacrylic acid sodium salt, cationic mistrials or a mixture thereof. Non-limiting examples of ink receptors which can be used in accordance with the present invention include, but are not limited to, the following commercial products: TruDot® from MeadWestvaco Corporation, Joncryl® from S.C. Johnson, or AcrylGen® from Omnova. Of these, polyacrylic resin is the preferred ink receptor.

A surfactant is used in the present invention to impart a degree of hydrophobicity to the finish to provide a sharp image on the fabric and also to provide lubricity, softness and draping characteristics to the fabric. Surfactants can be anything known to be used as surfactants: anionic, cationic, amphoteric, zwitterionic, nonionic surfactants or mixtures thereof.

Non-limiting examples of surfactants which can be used in accordance with the present invention include, but are not limited to, imidazoline quaternary compounds, quaternary ammonium compounds, quaternary ammonium salts, fatty amines, amidoamines, condensation products of C9-C30 alcohols with sugar or starch polymers, alkylene oxide esters of fatty acids, alkylene oxide diesters of fatty acids, alkylene oxide ethers of fatty alcohols, alkoyl isethionates, alkylether sulfates, alkyl imino acetates, carboxylates, sulfonates, sulfates, phosphates, phosphonates, iminodialkanoates, aminoalkanoates, betaines or mixtures thereof.

Of these, a quaternary ammonium salt or a mixture of quaternary ammonium salts is the preferred surfactant. More preferably, a surfactant which may be used in accordance with the present invention is Omega Softener® from Omega Chemicals Inc. or Incrosoft® T-90 from Croda Inc, or a mixture thereof.

A fluorescent whitening agent, which is also called an optical brightener, is used in the present invention to brighten colors of the image and to mask natural yellowing of fabrics, as well as to improve initial color of the image and provide brilliancy of colored articles. Fluorescent whitening agents of the present invention are nonionic materials.

Non-limiting examples of fluorescent whitening agents which can be used in accordance with the present invention include, but are not limited to, thiophene bis(benzoxazolyl), and ethylene bis-benzoxazolyls, or a mixture thereof. A preferred fluorescent whitening agent of the present invention which may be used in the composition of the invention is UVITEX® ERN, UVITEX® EBF or a mixture thereof.

A durable flame retardant is used in the present invention to meet the flame retardant requirements such as MVSS-302 and NFPA-701. The durable flame retardant is used in a pretreatment composition to pretreat all types of fabrics, preferably polyester fabrics.

Non-limiting examples of flame retardants which can be used in accordance with the present invention include, but are not limited to, a halogen-based compound, phosphate-based compound, phosphorus-based compound, inorganic compound or a mixture thereof. Preferably, the flame retardant of the present invention is a phosphate-based compound. More preferably, a flame retardant of the present invention is Pyrozyl® M73 from Amitech Inc.

Non-limiting examples of water which can be used in accordance with the present invention include, but are not limited to, softened tap water, distilled water, deionized water and a mixture thereof. Of these, softened tap water is preferred.

The composition may further include a thickening agent to adjust the viscosity of the pretreatment composition depending on the manufacturing process employed to apply the pretreatment composition to the fabric. Non-limiting examples of thickening agents, which can be used in accordance with the present invention without any limitation, include natural starch, British gum, crystal gum, natural and etherified locust bean gums, cellulose, methyl cellulose, hydroxyl ethyl cellulose, hydroxyl propyl methyl cellulose, carboxymethyl cellulose, gum tragacanth, polyacrylic acid sodium salt, sodium alginate or a mixture thereof.

A preferred thickening agent of the present invention is hydroxy ethyl cellulose from Union Carbide or hydroxy propyl methyl cellulose from Dow Chemical or a mixture thereof.

In a preferred embodiment, the composition may have about 5 weight % to 40 weight % of an ink receptor; about 0.5 weight % to 4 weight % of a surfactant; about 0.5 weight % to 10 weight % of a flame retardant; about 0.1 weight % to 5 weight % of a fluorescent whitening agent, and about :10 weight % to 90 weight % of water.

In another preferred embodiment, the composition may have about 5 weight % to about 20 weight % of an ink receptor; about 0.5 to about 2 weight % of a surfactant; about 1 weight % to about 5 weight % of a flame retardant; about 1 weight % to about 4 weight % of a fluorescent whitening agent; and about 60 weight % to about 90 weight % of water.

If a thickening agent is used to adjust the viscosity of the pretreatment composition to a suitable level depending on the manufacturing process to be employed for application of the pretreatment composition to the fabric, the composition may preferably have about 5 weight % to “40 weight % of an ink receptor; about 0.5 weight % to 4 weight % of a surfactant; about 0.5 weight % to 10 weight % of a flame retardant; about 0.1 weight % to 5 weight % of a fluorescent whitening agent, about 0.1 weight % to 2 weight % of a thickening agent; and about 10 weight % to 90 weight % of water.

Furthermore, the pretreatment composition of the present invention may further contain additives such as humectants, wetting agents, dispersion stabilizers, pigments, binders, anti-curling agents and mixtures thereof. The additive of the present invention can be present in an amount ranging from about 0.5 weight % to about 5.0 weight % with respect to the total weight of the pretreatment composition.

The pretreatment composition of the present invention can be manufactured on-site by mixing various ingredients mentioned above, or can be prepackaged and sold in containers of various sizes and quantities. The pretreatment composition of the present invention is stable at room temperature for at least about 3 months, and more preferably, about 6 months to a year.

In a preferred embodiment of the process for pretreating fabrics of the present invention, the pretreatment solution is prepared in a make-up tank equipped with a propeller-type mixer. First, water is charged at a mixer speed of approximately 1,750 rpm. Then all other ingredients, such as an ink receptor, a surfactant, a flame retardant, and a fluorescent whitening agent are added to the make-up tank and are mixed for about 5-15 minutes. Preferably, the pretreatment solution is a milky white emulsion having a pH of about 3-6 and a viscosity of between about 4 to about 250 cps. The wet pick-up of fabric is preferably about 50% to about 100%. Then the pretreatment solution is transferred into a dipping pan (1) to impregnate the fabric with the pretreatment solution (5).

Impregnation of fabric with the pretreatment solution is then accomplished by threading the fabric through a set of rollers (10) into the pretreatment solution (5) in the dipping pan (1). Then the solution-dipped fabric is threaded through a set of rubber squeeze rollers. (15) to remove the excess pretreatment solution. The pretreated fabric is then passed through a tenterframe (20 ) with multiple temperature zones at the speed of about 50 to 100 yards/minute to dry and stretch the fabric to a desired width and to straighten its weave. It is preferable to heat the pretreated fabric under gradually increasing temperature conditions in the tenterframe, for example, starting at 275° F., then at 350° F. and then finally at 400° F. Such tenterframe is supplied by D. R. Kenyon & Sons Inc., and is widely available in all dye houses. However, comparable results should be obtained from other systems. Then the fabric is threaded between the cooling rollers (25) decreasing the temperature of the fabrics, and subsequently is batched on a roll (30).

An advantage of using the dipping process, as opposed to screen-printing or coating process, to apply the pretreatment composition of the present invention to a fabric is that both sides of the fabric are pretreated and therefore can be used for printing directly thereon from a printer on either or both sides.

After the fabric is pretreated, a color image can be applied, preferably digitally, onto the fabric and then the fabric with the image is heat-set at about 350° F. to about 420° F. for about 1 to 60 seconds, preferably at about 400° F. for about 30 seconds.

In one preferred process, a colored image is printed directly onto a pretreated fabric of the present invention by first digitizing the image and making the color corrections to the digitized image; sending disperse dyes through a wide format digital drop-on-demand print head which dispenses the colored inkjet inks in precise patterns; printing directly onto the pretreated fabric and then drying; and finally heat-setting the fabric at about 350° F. to about 420° F. for about 1 to 60 seconds, preferably at about 400° F. for about 30 seconds.

During the direct printing process, there is a synergistic effect between the ink and the pretreatment composition in the pretreated fabric as the ink volatizes or sublimes and migrates to the pretreated fabric providing better than or at least the same degree of color yield, sharpness and brilliancy as the images that are heat transfer printed onto a fabric from a paper.

In another preferred embodiment, a pretreatment composition is prepared by mixing an ink receptor, a surfactant, a flame retardant, a fluorescent whitening agent and water. With the further addition of a thickening agent, the viscosity of the pretreatment composition is then adjusted to about 1,000 to about 3,000 cps. The paste-like pretreatment composition is used to pretreat the fabric by rolling the paste-like pretreatment composition directly onto the fabric or extending the paste-like pretreatment from a circular or flat perforated screen onto said fabric. As an example, the Zimmer® screen printing machine is one of the commercial products which can be used to apply the pretreatment directly onto the fabric. However, comparable results should be obtained from other systems as well.

In yet another preferred embodiment, a pretreatment composition is prepared by mixing an ink receptor, a surfactant, a flame retardant, a fluorescent whitening agent and water. With the further addition of a thickening agent, the viscosity of the pretreatment composition is then adjusted to about 10,000 to about 30,000 cps to coat the fabric with the pretreatment composition to pretreat the fabric. The Zimmer® coating machine is one of the commercial products available which can be used to coat the fabric with the pretreatment composition. However, comparable results should be obtained from other systems as well.

### EXAMPLES

| | Example | |
|---|---|---|
| | 1 | 2 |
| Components | weight % | weight % |
| Ink receptor (AcrylGen ®) | 10 | 10 |
| Surfactant (Omega Softener ®) | 1.5 | 0.5 |
| Flame retardant (Pyrozyl ® M73) | 1.5 | 2.5 |
| Fluorescent whitening agent (UNITEX ® ERN) | 3 | 2 |
| Water (softened tap water) | 84 | 85 |

A mixture having the above formulations illustrated in Examples 1-2 were used to prepare a pretreatment composition. Such pretreatment composition was applied to a polyester fabric by using the dipping process described above.

The colored image on the fabric pretreated with the present invention provided better than or at least the same degree of color yield, sharpness and brilliancy as the images that are heat transfer printed onto a fabric from a paper, while imparting lubricity, softness and draping characteristics to the fabrics.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A pretreatment composition for pretreating a fabric for use in direct printing comprising:
about 5 to about 40 weight % of an ink receptor,
about 10 to about 90 weight % of water,
about 0.5 to about 4 weight % of a surfactant,
about 0.1 to about 5 weight % of a fluorescent whitening agent, and
about 0.5 to about 10 weight % of a flame retardant.

2. The pretreatment composition of claim 1, wherein said fabric is natural fabric, synthetic fabric, or blended fabric.

3. The pretreatment composition of claim 1, wherein said ink receptor is a polyacrylic resin, styrene-acrylic copolymer, a mixture of polyacrylic resins, cross-linked polyvinylpyrrolidone, cross-linked polyacrylic acid sodium salt, cationic mistrials or a mixture thereof.

4. The pretreatment composition of claim 3, wherein said ink receptor is a polyacrylic resin.

5. The pretreatment composition of claim 1, wherein said water is softened tap water, filtered water, distilled water, deionized water or a mixture thereof.

6. The pretreatment composition of claim 5, wherein said water is softened tap water.

7. The pretreatment composition of claim 1, wherein said surfactant is an imidazoline quaternary compound, a quaternary ammonium compound, a quaternary ammonium salt, fatty amine, amidoamine, a condensation product of C9-C30 alcohols with sugar or starch polymers, an alkylene oxide ester of fatty acids, an alkylene oxide diester of fatty acids, an alkylene oxide ether of fatty alcohols, alkoyl isethionate, alkylether sulfate, alkyl imino acetate, carboxylate, sulfonate, sulfate, phosphate, phosphonate, iminodialkanoate, aminoalkanoate, betaine or a mixture thereof.

8. The pretreatment composition of claim 7, wherein said surfactant is a quaternary ammonium salt or a mixture of quaternary ammonium salts.

9. The pretreatment composition of claim 1, wherein said fluorescent whitening agent is a thiophene bis (benzoxazolyl), ethylene bis-benzoxazolyl, a substituted derivative, or a mixture thereof.

10. The pretreatment composition of claim 9, wherein said fluorescent whitening agent is a bis benzoxazole or a mixture of bis benzoxazoles.

11. The pretreatment composition of claim 1, wherein said flame retardant is a halogen-based compound, phosphate-based compound, phosphorus-based compound, inorganic compound or a mixture thereof.

12. The pretreatment composition of claim 11, wherein said flame retardant is a phosphate based compound or a mixture of phosphate based compounds.

13. The pretreatment composition of claim 1, wherein said ink receptor is present in an amount ranging from about 5 weight % to about 20 weight % with respect to the total weight of said pretreatment composition.

14. The pretreatment composition of claim 1, wherein said water is present in an amount ranging from about 60 weight % to about 90 weight % with respect to the total weight of said pretreatment composition.

15. The pretreatment composition of claim 1, wherein said surfactant is present in an amount ranging from about 0.5 weight % to about 2 weight % with respect to the total weight of said pretreatment composition.

16. The pretreatment composition of claim 1, wherein said fluorescent whitening agent is present in an amount ranging from about 1 weight % to about 4 weight % with respect to the total weight of said pretreatment composition.

17. The pretreatment composition of claim 1, wherein said flame retardant is present in an amount ranging from about 1 weight % to about 5 weight % with respect to the total weight of said pretreatment composition.

18. The pretreatment composition of claim 1, wherein said pretreatment has a viscosity of between about 4 to about 250 cps.

19. The pretreatment composition of claim 1, wherein said pretreatment has a pH of between about 3 to about 5.

20. The pretreatment composition of claim 1, further comprising about 0.1 weight % to about 2 weight % of a thickening agent with respect to the total weight of said pretreatment composition.

21. The pretreatment composition of claim 20, wherein said thickening agent is natural starch, British gum, crystal gum, natural and etherified locust bean gums, cellulose, methyl cellulose, hydroxyl ethyl cellulose, hydroxyl propyl methyl cellulose, carboxymethyl cellulose, gum tragacanth, polyacrylic acid sodium salt, sodium alginate or a mixture thereof.

22. The pretreatment composition of claim 21, wherein said thickening agent is hydroxyl ethyl cellulose.

23. The pretreatment composition of claim 1, further comprising an additive.

24. The pretreatment composition of claim 23, wherein said additive is a humectant, a wetting agent, a dispersion stabilizer, a pigment, a binder, an anti-curling agents or a mixture thereof.

25. The pretreatment composition of claim 23, wherein said additive is present in an amount ranging from about 0.5 weight % to about 5.0 weight % with respect to the total weight of the pretreatment composition.

26. A method of applying a pretreatment composition to a fabric for use in direct printing comprising:
applying a pretreatment composition comprising about 5 weight % to about 40 weight % of an ink receptor, about 10 weight % to about 90 weight % of water, about 0.5 weight % to about 4 weight % of a surfactant, about 0.1 weight % to about 5 weight % of a fluorescent whitening agent, and about 0.1 weight % to about 10 weight % of a flame retardant to a fabric, and
drying said fabric thereafter.

27. The method of claim 26, wherein said step of applying said pretreatment composition to said fabric is performed by dipping said fabric into said pretreatment composition.

28. The method of claim 26, wherein said step of applying said pretreatment composition to said fabric is performed by rolling said pretreatment composition directly onto said fabric or extending from a circular or flat perforated screen onto said fabric.

29. The method of claim 26, wherein said step of applying said pretreatment composition to said fabric is performed by coating said pretreatment composition onto said fabric.

30. A method of directly printing onto a pretreated fabric comprising:
applying a pretreatment composition comprising about 5 weight % to about 40 weight % of an ink receptor, about 10 weight % to about 90 weight % of water, about 0.5 weight % to about 4 weight % of a surfactant, about 0.1 weight % to about 5 weight % of a fluorescent whitening agent, and about 0.1 weight % to about 10 weight % of a flame retardant to a fabric,
drying said fabric thereafter,
printing directly onto said pretreated fabric, and
heat-setting said pretreated fabric with a print for about 1 to 60 seconds at about 350OF to about 420° F.
